(19) United States
(12) Patent Application Publication
(10) Pub. No.: US 2020/0048586 A1
(43) Pub. Date: Feb. 13, 2020

(54) COMPOSITION CONTAINING ERYTHRITOL AS ACTIVE INGREDIENT, METHOD FOR PRODUCING TABLET USING THE SAME, AND TABLET

(71) Applicant: B FOOD SCIENCE CO., LTD., Chita-shi (JP)

(72) Inventors: Mayuko TAKAHASHI, Chita-shi (JP); Yuki KIMURA, Chita-shi (JP); Takumi TOCHIO, Chita-shi (JP)

(21) Appl. No.: 16/532,802

(22) Filed: Aug. 6, 2019

(30) Foreign Application Priority Data
Aug. 7, 2018 (JP) 2018-148263

(51) Int. Cl. C11D 17/00; C11D 3/22

(52) U.S. Cl. CPC C11D 17/0073; C11D 3/222

(57) ABSTRACT

[Problem to be Solved] An art imparting, to a tablet, excellent functionality that dissolution of a tablet is delayed, that foaming time of a foaming tablet is elongated, that air bubbles generated from a foaming tablet are fined, or that a concentration, in a liquid, of a gas obtained by a foaming tablet is increased is provided. Besides, a method for producing a tablet using the same, and a tablet are provided.

[Solution] A composition, for delaying dissolution of a tablet, containing erythritol as an active ingredient, a method for producing a tablet using the same, and a tablet containing erythritol. According to the present invention, excellent functionality can be imparted to a tablet. Besides, a tablet having improved functionality can be easily produced.

### TECHNICAL FIELD

The present invention relates to a composition that contains erythritol as an active ingredient and imparts excellent functionality to a tablet, a method for producing a tablet using the same, and a tablet.

### BACKGROUND ART

A tablet is, in general, a solid formulation obtained by forming an active ingredient or a mixture of an active ingredient and an auxiliary material such as an excipient into a prescribed shape by compression molding or the like. Tablets have been conventionally produced as products in various fields including internal or oral pharmaceuticals, food such as sweets, bath additives, detergents and the like.

In use of many of tablets, an active ingredient is eluted out by dissolving the tablet in a liquid. Some products are, however, required to have longer time (dissolution time) until complete dissolution of the tablet. Such a product is, for example, a controlled release tablet whose dissolution is delayed for causing its medical effect to persist for a prescribed period of time. Besides, a foaming tablet such as a foaming bath additive or food like foaming candy or gummy candy is required to provide lasting foaming feeling.

Patent Literature 1 discloses food whose surface is coated with a sugar coating having an irregular pattern to have a foaming component in a recess portion for causing foaming time to persist longer than in other conventional food. Besides, Patent Literature 2 discloses a bath additive in which a foaming component is covered with a specific wrapping material to control a contact with bathwater for elongating foaming time.

### CITATION LIST

### Patent Literature

[Patent Literature 1] Japanese Patent No. 5407811
[Patent Literature 2] Japanese Patent No. 6110102

### SUMMARY OF INVENTION

### Technical Problem

The techniques described in Patent Literature 1 and Patent Literature 2 need, however, a special coating method or wrapping material, and hence are limited in the production facility or the production method, and it is apprehended that the production cost may be increased. In other words, even in consideration of these patent literatures, a simple technique for delaying dissolution of a tablet or elongating foaming time of a foaming tablet has not been sufficiently provided in the current state.

The present invention was devised to solve this problem, and an object is to provide an art imparting, to a tablet, excellent functionality that dissolution of a tablet is delayed, that foaming time of a foaming tablet is elongated, that air bubbles generated from a foaming tablet are fined, or that a concentration, in a liquid, of a gas obtained by a foaming tablet is increased. Besides, another object is to provide a method for producing a table using the same, and a tablet.

### Solution to Problem

As a result of earnest studies, the present inventors have found that erythritol delays dissolution of a tablet, elongates foaming time of a foaming tablet, fines air bubbles generated from a foaming tablet, increases a concentration, in a liquid, of a gas obtained by a foaming tablet, and imparts excellent taste quality to a foaming tablet of food. Therefore, based on these findings, the following inventions were accomplished.

(1) A tablet according to the present invention contains erythritol. The tablet according to the present invention may exclude food and an oral pharmaceutical.

(2) The tablet according to the present invention may be a tablet used as a daily necessity.

(3) The tablet according to the present invention may be a tablet used as an industrial product.

(4) The tablet according to the present invention may be a tablet used as a cleaning supply.

(5) The tablet according to the present invention may be a bath additive or a detergent.

(6) The tablet according to the present invention may be a foaming tablet.

(7) The foaming tablet according to the present invention may be a foaming bath additive or a foaming detergent.

(8) A method for delaying dissolution of a tablet according to the present invention includes a step of delaying dissolution of a tablet by containing erythritol as a component of the tablet.

(9) A method for elongating foaming time of a foaming tablet according to the present invention includes a step of elongating foaming time of a foaming tablet by containing erythritol as a component of the foaming tablet.

(10) A method for fining air bubbles generated from a foaming tablet according to the present invention includes a step of fining air bubbles generated from a foaming tablet by containing erythritol as a component of the foaming tablet.

(11) A method for increasing a concentration, in a liquid, of a gas obtained by a foaming tablet according to the present invention includes a step of increasing a concentration of a gas in a liquid obtained by a foaming tablet by containing erythritol as a component of the foaming tablet.

(12) In the method for increasing a concentration, in a liquid, of a gas obtained by a foaming tablet according to the present invention, the gas may be carbon dioxide.

(13) A method for producing a tablet according to the present invention includes a step of tableting a raw material containing erythritol.

(14) A composition for delaying dissolution of a tablet according to the present invention contains erythritol as an active ingredient.

(15) A composition for elongating foaming time of a foaming tablet according to the present invention contains erythritol as an active ingredient.

(16) A composition for fining air bubbles generated from a foaming tablet according to the present invention contains erythritol as an active ingredient.

(17) A composition for increasing a concentration, in a liquid, of a gas obtained by a foaming tablet according to the present invention contains erythritol as an active ingredient.

(18) In the composition for increasing a concentration of a gas according to the present invention, the gas may be carbon dioxide.

(19) A method for producing a tablet according to the present invention includes a step of tableting a raw material containing the composition according to the present invention.

### Advantageous Effects of Invention

According to the present invention, dissolution of a tablet can be delayed. Therefore, the present invention can make a contribution to improvement of, for example, functionality that a detergent effect of a detergent can be persisted for a prescribed period of time, or that a medical effect of a pharmaceutical can be persisted for a prescribed period of time.

Besides, according to the present invention, foaming time of a foaming tablet can be elongated. Therefore, the present invention can make a contribution to improvement of, for example, functionality that foaming feeling of foaming food of sweets or the like or a foaming bath additive can be enjoyed for a longer period of time.

Furthermore, according to the present invention, air bubbles generated from a foaming tablet can be fined. Therefore, the present invention can make a contribution to improvement of, for example, functionality of fine texture or good mouthfeel of foaming food, a fine feel of a foaming bath additive, or a high detergent effect covering a small aperture of a foaming detergent.

Besides, according to the present invention, a concentration of a gas, in a liquid, obtained after dissolving a foaming tablet can be increased. Therefore, the present invention can make a contribution to improvement of, for example, functionality that a warm bath effect of a foaming bath additive is improved, or that an oxygen dissolving effect of an oxygen generating agent for breeding an aquatic animal is improved.

Furthermore, according to the present invention, a tablet improved in the functionality as described above can be easily produced.

### BRIEF DESCRIPTION OF DRAWINGS

FIG. 1 is a image observed with a stereomicroscope illustrating air bubbles generated from foaming tablets respectively containing erythritol (No. 1) and sorbitol (No. 2).

FIG. 2 is a graph illustrating diameters and frequencies of air bubbles generated from foaming tablets respectively containing erythritol (No. 1), sorbitol (No. 2) and glucose (No. 3).

FIG. 3 is a graph illustrating a carbon dioxide concentration in a liquid (pH 4) obtained after dissolving a foaming tablet containing erythritol (No. 1) or sorbitol (No. 2).

FIG. 4 is a graph illustrating a carbon dioxide concentration in a liquid (pH 7) obtained after dissolving a foaming tablet containing erythritol (No. 1) or sorbitol (No. 2).

FIG. 5 is a graph illustrating evaluation results for taste quality of a foaming tablet containing erythritol (No. 1). It is noted that scores of the tablet No. 1 are obtained with a score (3) of a foaming tablet containing sorbitol (No. 2) used as a reference.

### DESCRIPTION OF EMBODIMENT

The present invention will now be described in detail.

In the present invention, a tablet refers to a one obtained by compression molding, into a prescribed shape, of a raw material containing an active ingredient (including taste component and nutrient component) or a mixture of an active ingredient and an auxiliary material such as an excipient. The present invention is applicable particularly to a tablet that is dissolved, at a time of use by an ultimate consumer, in a liquid for eluting the active ingredient out into the liquid. The use of the tablet is not especially limited as long as it is dissolved in a liquid in use, and the invention is applicable to tablets for various uses including, for example, pharmaceuticals, food and drink, and daily necessities, industrial products, cleaning supplies and the like such as bath additives and detergents. The dimension, the weight, and the shape of the tablet are also not limited, and can be appropriately set in accordance with the use, the active ingredient and the like.

One aspect of the tablet according to the present invention may be a tablet excluding food. Another aspect may be a tablet excluding an oral pharmaceutical. Specific examples of the tablet excluding food and an oral pharmaceutical include the daily necessities, the industrial products, the cleaning supplies and the like such as the aforementioned bath additives and detergents. It is noted that the “oral pharmaceutical” herein refers to those oral intake among products aiming to affect the physical structure or function of a human.

In the present invention, a foaming tablet refers to a tablet generating air bubbles through a contact with a liquid. In other words, the foaming tablet contains a component causing a reaction to generate a gas through a contact with a liquid (foaming component). Examples of the foaming component include, but are not limited to, sodium bicarbonate and an acid (generating carbon dioxide) and calcium peroxide (generating oxygen), and any component can be used as long as it causes a gas generating reaction.

The present invention provides the following compositions (a) to (d). In the following description, these compositions are sometimes designated, as a whole, as the “present composition” or the “composition of the present invention”.

(a) A composition, for delaying dissolution of a tablet, containing erythritol as an active ingredient;

(b) a composition, for elongating foaming time of a foaming tablet, containing erythritol as an active ingredient;

(c) a composition, for fining air bubbles generated from a foaming tablet, containing erythritol as an active ingredient; and

(d) a composition for increasing a concentration, in a liquid, of a gas obtained by a foaming tablet, containing erythritol as an active ingredient.

Erythritol is a sugar alcohol having a chemical name of 1,2,3,4-butaneterol. Commercially available erythritol may be used, or erythritol produced by those skilled in the art by a known method may be used.

An example of the known method includes a method in which erythritol-producing microorganisms are cultured and produced using glucose or the like as a carbon source, and the resultant is purified. Here, examples of the erythritol-producing microorganisms include microorganisms belonging to the genus Trigonopsis or the genus Candida (Japanese Patent Publication No. 47-41549), microorganisms belonging to the genus Torulopsis, the genus Hansenula, the genus Pichia or the genus Debaryomyces (Japanese Patent Publication No. 51-21072), microorganisms belonging to the genus Moniliella (Japanese Patent Laid-Open No. 60-110295, Japanese Patent Laid-Open No. 10-215887), microorganisms belonging to the genus Aureobasidium (Japanese Patent Publication No. 63-9831), and microorganisms belonging to the genus Yarrowia (Japanese Patent Laid-Open No. 10-215887), and culturing conditions can be usual conditions suitable for these microorganisms. Besides, erythritol can be purified by an ordinary method including steps of cell separation, preparative isolation of erythritol by chromatography, desalting, decolorization, crystallization, crystal decomposition and drying.

Commercially available erythritol or erythritol produced by the aforementioned method may be directly used, or may be formed, by granulation, into a granule (erythritol granule) containing erythritol as a principal component before use.

A granulation method is, for example, a method in which a spray-liquid containing a binder is sprayed onto a powder of erythritol under stirring, and the resultant is dried. As the binder, a cellulose derivative such as hydroxypropyl cellulose (HPC) or hydroxypropyl methylcellulose (HPMC) can be used. A concentration of the HPC or the HPMC in the spray-liquid can be, for example, 2.5 to 30% by mass. The granulation method can be performed by employing a fluidized bed granulation method as described later as Test Method (2) in an example, or can be performed by employing an agitation granulation method, a spray drying method or the like.

Erythritol is combined with another raw material to be contained in the tablet, and the resultant is tableted for use. In other words, the present invention also provides a method for producing a tablet including a step of tableting a raw material containing erythritol. Here, a tableting method is divided into a “dry direct compression method (direct tableting method)” in which an active ingredient and an auxiliary material such as an excipient are mixed and the resultant is directly tableted without adding water thereto, and a “wet granulation tableting method” in which a mixture of an active ingredient and an auxiliary material is granulated with a proper solvent such as a binder solution or water, and the resultant is dried and then tableted, and either of these methods can be employed in the present invention.

The raw material, excluding erythritol, contained in the tablet can be appropriately set according to a use of the tablet. A content rate of erythritol in the raw material or the tablet is not especially limited, and can be, for example, 1 to 100% by mass, 1 to 99% by mass, 1 to 98% by mass, 10 to 98% by mass, 15 to 98% by mass, 20 to 98% by mass or the like.

In the present invention, that “dissolution of a tablet is delayed” refers to that time from a contact between the tablet and a liquid to completion of the dissolution of the tablet (dissolution time) is elongated. Here, it can be checked whether or not the dissolution time is elongated by putting a tablet containing erythritol and a tablet not containing erythritol into a liquid under the same conditions to compare dissolution time. When the dissolution time of the former tablet is longer, it can be determined that the dissolution of the tablet is delayed by erythritol.

In the present invention, that “foaming time of a foaming tablet is elongated” refers to that time from the start of foaming due to a contact between the foaming tablet and a liquid to the end of the foaming due to dissolution of the foaming tablet (foaming time) is elongated. Here, it can be checked whether or not the foaming time is elongated by putting a foaming tablet containing erythritol and a foaming tablet not containing erythritol into a liquid under the same conditions to compare foaming time. When the foaming time of the former foaming tablet is longer, it can be determined that the foaming time of the foaming tablet is elongated by erythritol.

In the present invention, that “air bubbles generated from a foaming tablet are fined” refers to that air bubbles generated through a contact between the foaming tablet and a liquid become smaller. Here, it can be checked whether or not the air bubbles are fined by putting a foaming tablet containing erythritol and a foaming tablet not containing erythritol into a liquid under the same conditions to compare the sizes of the generated air bubbles. When the air bubbles of the former foaming tablet are smaller, it can be determined that the air bubbles generated from the foaming tablet are fined by erythritol. Incidentally, a very large number of air bubbles are generated in general, and their sizes are varied. The term “the air bubbles are fined” herein does not refer to that all the generated air bubbles are small but refers to that a ratio in number of small air bubbles is increased, or that an average diameter of the air bubbles is reduced.

In the present invention, that “a concentration, in a liquid, of a gas obtained by a foaming tablet is increased” refers to that a concentration, in a liquid, of a gas generated through a contact between the foaming tablet and the liquid is increased. Here, it can be checked whether or not the concentration of a gas in the liquid is increased by putting a foaming tablet containing erythritol and a foaming tablet not containing erythritol into a liquid under the same conditions to compare the gas concentration in the liquid. When the concentration obtained by the former foaming tablet is higher, it can be determined that the concentration of the gas in the liquid obtained by the foaming tablet is increased by erythritol.

[symbol] The present invention provides a tablet containing erythritol. Erythritol has, as described above, the effect to delay the dissolution of a tablet, to elongate the foaming time of a foaming tablet, to fine air bubbles generated from a foaming tablet, or to increase the concentration, in a liquid, of a gas obtained by a foaming tablet, and therefore, the present tablet is a tablet possessing such excellent functionality. The present tablet can be suitably used for application utilizing such functionality, for example, as a tablet for use of a daily necessity, an industrial product or a cleaning supply such as a bath additive or a detergent, or, as a foaming tablet such as a foaming bath additive or a foaming detergent.

The present invention will now be described based on examples. It is noted that the technical scope of the present invention is not limited to features described in these examples.

### EXAMPLES

### <Test Method>

The examples were performed by a method described in the following (1) to (3) unless otherwise stated. Besides, “%” means “% by mass” in these examples unless otherwise stated.

### (1) Excipient

Excipients used in the examples are shown in Table 1 below.

TABLE 1

| Component | Product Name | Manufacturer |
|---|---|---|
| Erythritol | Erythritol 50M | B Food Science Co., Ltd. |
| Erythritol Granule | Prepared as described in Test Method (2) | |
| Sorbitol | Sorbitol TBS | B Food Science Co., Ltd. |
| Glucose | Glu-Final | San-ei Sucrochemical Co., Ltd. |
| Crystalline cellulose | Ceolus KG-802 | Asahi Kasei Corporation |

### (2) Preparation of Erythritol Granule

A granulator “Multiplex FD-MP-01ND (Powrex Corp.)” was charged with erythritol in the form of a powder (Erythritol 50 M (B Food Science Co., Ltd.)), and granulation was performed under spray of a spray-liquid with a hot air set to inlet temperature of 80° C., air flow set to 0.6 m³/min, and a spray pressure set to 0.2 MPa. As the spray-liquid, an aqueous solution of hydroxypropyl cellulose (HPC SSL SFP (Nippon Soda Co., Ltd.)) dissolved in a concentration of 9% was used. The prepared erythritol granule contained HPC in a concentration of 3%.

### (3) Preparation of Tablet

A mixture of each of the excipients of Table 1, dextrin (TK-16AG (Matsutani Chemical Industry Co., Ltd.)) and a lubricant (Sugar Ester S-370F (Mitsubishi Chemical Foods Corporation)) was charged in a continuous single punch tableting machine “AUTOTAB 200 (Ichihashi Seiki Co., Ltd.)”, and was compression molded at a tableting pressure of 1.0 to 12.0 kN into a circular tablet having an ordinary R. The size of each tablet was set to a diameter of 8 mm and a weight of 200 mg, or a diameter of 10 mm and a weight of 600 mg. For preparing a foaming tablet, sodium bicarbonate (Wako Pure Chemical Industries Ltd.) and anhydrous citric acid (“Citric Acid Fuso (Anhydrous)”, Fuso Chemical Co., Ltd.) were used instead of dextrin. Tablet hardness was measured using a load-cell type tablet hardness tester DC-30 (Okada Seiko Co., Ltd.).

### Example 1

### Dissolution Time of Tablet

Tablets No. 1 to No. 5 (diameter: 8 mm, 200 mg/tablet) were prepared in accordance with compositions shown in Table 2, and the tablet hardness of each tablet was measured. Each of these tablets was introduced into a water tank holding deionized water at 37° C. therein, and time necessary from the introduction to completion of dissolution of the tablet was measured with the water tank vertically moved at a stroke of 30 cycles/min, and the thus obtained time was defined as the dissolution time. This test was performed using a disintegration tester (NT-200 (Toyama Sangyo Co., L.td). The results are shown in the lowermost row of Table 2.

TABLE 2

| | | Tablet No. | | | | |
|---|---|---|---|---|---|---|
| | | No. 1 | No. 2 | No. 3 | No. 4 | No. 5 |
| Component | Erythritol | 49 | 0 | 0 | 0 | 0 |
| | Erythritol Granule | 0 | 49 | 0 | 0 | 0 |
| | Sorbitol | 0 | 0 | 49 | 0 | 0 |
| | Glucose | 0 | 0 | 0 | 49 | 0 |
| | Crystalline cellulose | 0 | 0 | 0 | 0 | 49 |
| | Dextrin | 49 | 49 | 49 | 49 | 49 |
| | Lubricant | 2 | 2 | 2 | 2 | 2 |

| | | | | | |
|---|---|---|---|---|---|
| Tablet Hardness (N) | 34 | 32 | 32 | 28 | 28 |
| Dissolution Time (sec) | 303.7 | 318 | 79.3 | 242 | 102 |

As shown in Table 2, although all the tablets No. 1 to No. 5 had equivalent tablet hardness of about 30 N, the tablets No. 1 and No. 2 had remarkably long dissolution time as compared with the tablets No. 3 to No. 5. In other words, it was revealed that a tablet containing erythritol requires remarkably long time to the completion of dissolution. It was revealed, based on this result, that erythritol delays the dissolution of a tablet.

### Example 2

### Foaming Time of Foaming Tablet

Tablets No. 1 to No. 3 (diameter: 10 mm, 600 mg/tablet) were prepared in accordance with compositions shown in Table 3, and the tablet hardness of each tablet was measured. Each of these tablets was introduced into a water tank holding 200 mL of deionized water therein, and time from the start of foaming to the end of the foaming was measured, and the thus obtained time was defined as the foaming time. The start and the end of the foaming were visually determined. The results are shown in the lowermost row of Table 3.

TABLE 3

| | | Tablet No. | | |
|---|---|---|---|---|
| | | No. 1 | No. 2 | No. 3 |
| Component | Erythritol Granule | 58 | 0 | 0 |
| | Sorbitol | 0 | 58 | 0 |
| | Glucose | 0 | 0 | 58 |
| | Citric Acid | 20 | 20 | 20 |
| | Sodium Bicarbonate | 20 | 20 | 20 |
| | Lubricant | 2 | 2 | 2 |

| | | | |
|---|---|---|---|
| Tablet Hardness (N) | 51 | 54 | 47 |
| Foaming Time (sec) | 233 | 58 | 45 |

As shown in Table 3, although all the tablets No. 1 to No. 3 had equivalent tablet hardness of about 50 N, the tablet No. 1 had remarkably long foaming time as compared with the tablets No. 2 and No. 3. In other words, it was revealed that a tablet containing erythritol has remarkably long foaming time. It was revealed based on this result that erythritol elongates foaming time of a foaming tablet.

### Example 3

### Size of Air Bubbles of Foaming Tablet

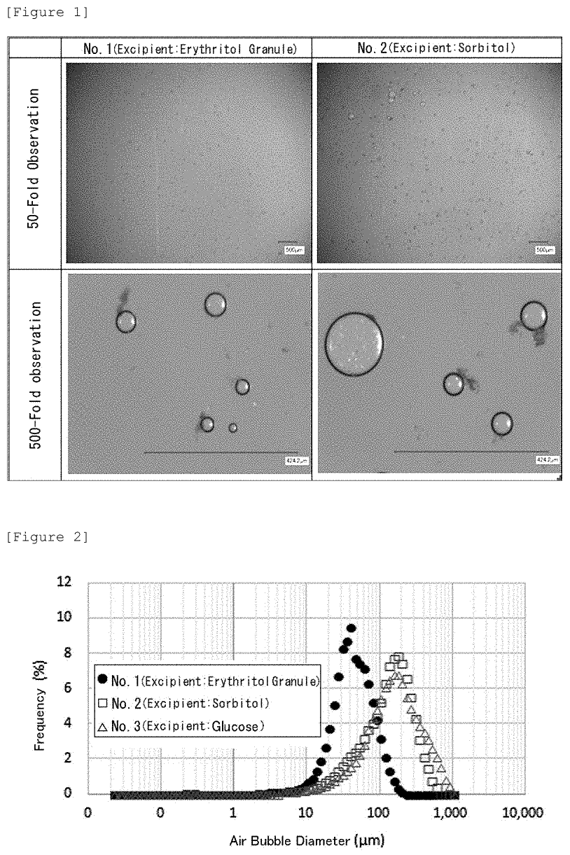

Tablets No. 1 to No. 3 (diameter: 10 mm, 600 mg/tablet) were prepared in accordance with compositions shown in Table 4. Each of these tablets was introduced into a water tank holding 20 mL of deionized water therein, and air bubbles generated from the tablet were observed with a stereomicroscope VHX-6000 (Keyence Corporation). Observed images of the tablets No. 1 and No. 2 are illustrated in FIG. 1. Besides, from the start of foaming to the end of the foaming, sizes of the air bubbles (air bubble diameters) were measured using a laser diffraction scattering particle size distribution measuring apparatus (LA910 (Horiba Ltd.)). The results are shown in FIG. 2. Besides, a cumulative 50% diameter (d50: μm) and a cumulative 10% diameter (d10: μm) are shown in the lowermost rows of Table 4.

TABLE 4

| | | Tablet No. | | |
|---|---|---|---|---|
| | | No. 1 | No. 2 | No. 3 |
| Component | Erythritol Granule | 58 | 0 | 0 |
| | Sorbitol | 0 | 58 | 0 |
| | Glucose | 0 | 0 | 58 |
| | Citric Acid | 20 | 20 | 20 |
| | Sodium Bicarbonate | 20 | 20 | 20 |
| | Lubricant | 2 | 2 | 2 |

| | | | |
|---|---|---|---|
| Cumulative distribution 50% diameter (μm) | 37.4 | 127.6 | 141 |
| Cumulative distribution 10% diameter (μm) | 16.6 | 32.8 | 41.7 |

As illustrated in FIGS. 1 and 2 and Table 4, the air bubble diameters of the tablet No. 1 were remarkably smaller than those of the tablets No. 2 and No. 3. In other words, it was revealed that the size of air bubbles generated from a foaming tablet containing erythritol is remarkably small. It was revealed based on this result that erythritol fines air bubbles of a foaming tablet.

### Example 4

### Gas Concentration in Liquid Obtained After Dissolution of Foaming Tablet

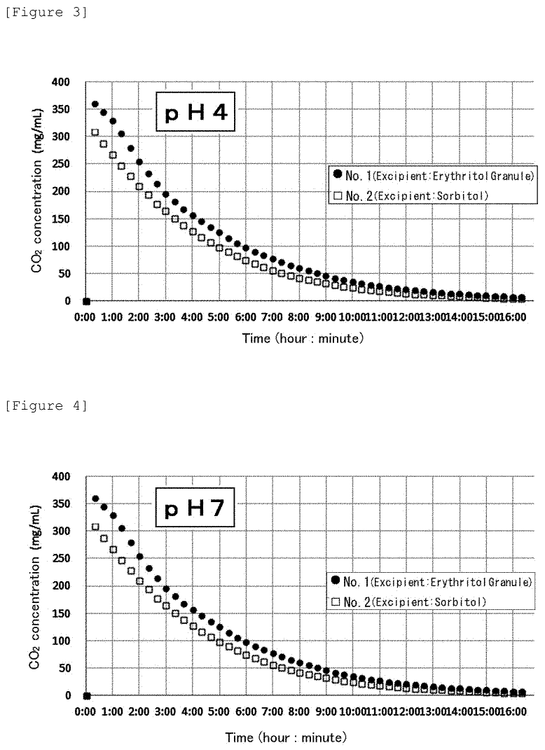

Tablets No. 1 and No. 2 (diameter: 8 mm, 200 mg/tablet) were prepared in accordance with compositions shown in Table 5. Each of these tablets was introduced into a water tank holding 50 mL of deionized water (pH 4 or pH 7) under a room temperature environment to be dissolved therein. After visually confirming completion of the dissolution (end of foaming), a carbon dioxide concentration was measured over time from the completion of the dissolution to 16 hours after using a portable carbon dioxide gas concentration measuring device “CGP-31 (DKK-Toa Corporation)”. Measurement results obtained at pH 4 are illustrated in FIG. 3, and measurement results obtained at pH 7 are illustrated in FIG. 4. Besides, the maximum concentration during the measurement time, and time necessary to obtain a concentration of 300 mg/mL, 200 mg/mL or 100 mg/mL after reaching the maximum concentration are shown in the lowermost rows of Table 5.

TABLE 5

| | | Tablet No. | |
|---|---|---|---|
| | | No. 1 | No. 2 |
| Component | Erythritol Granule | 58 | 0 |
| | Sorbitol | 0 | 58 |
| | Citric Acid | 20 | 20 |
| | Sodium Bicarbonate | 20 | 20 |
| | Lubricant | 2 | 2 |
| CO₂ | Maximum Concentration (mg/mL) | 404 | 350 |
| Concentration | Time to Reach 300 mg/mL (Hour:minute) | 1:35 | 0:39 |
| (pH 4) | Time to Reach 200 mg/mL (Hour:minute) | 3:26 | 1:57 |
| | Time to Reach 100 mg/mL (Hour:minute) | 6:13 | 4:06 |
| CO₂ | Maximum Concentration (mg/mL) | 365 | 324 |
| Concentration | Time to Reach 300 mg/mL (Hour:minute) | 1:26 | 0:29 |
| (pH 7) | Time to Reach 200 mg/mL (Hour:minute) | 2:57 | 2:14 |
| | Time to Reach 100 mg/mL (Hour:minute) | 5:58 | 5:00 |

As illustrated in FIGS. 3 and 4 [symbol] the carbon dioxide concentration was higher in using the tablet No. 1 in either measurement time as compared with the tablet No. 2. And as illustrated in Table 5, maximum concentration of the tablet No. 1 was higher as compared with the tablet No. 2 in liquid of either hydrogen-ion exponent. Furthermore, with respect to the time until carbon dioxide gas concentration is lowered from maximum concentration to the prescribed concentration, the tablet No. 1 needed more time as compared with the tablet No. 2. In other words, it was revealed that a gas concentration is higher in a liquid in which a foaming tablet containing erythritol has been dissolved. It was revealed based on this result that erythritol increases a concentration of a gas in a liquid obtained by dissolving a foaming tablet.

### Example 5

### Sensory Evaluation of Foaming Tablet

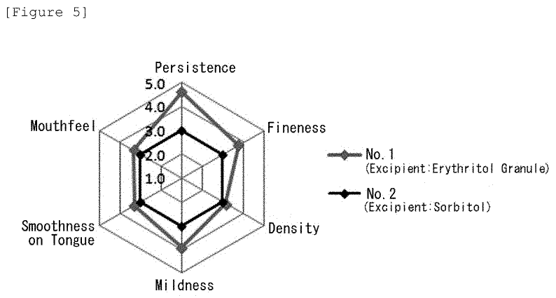

Tablets No. 1 and No. 2 (diameter: 8 mm, 200 mg/tablet) were prepared in accordance with compositions shown in Table 6. Each of these tablets was subjected to a sensory test by seven panelists to evaluate foaming time and taste quality. In Example 5, the tablet was not bitten but allowed to melt on the tongue for the evaluation. Time from a moment when each tablet was put into the mouth to be placed on the tongue to complete melt of the tablet was measured, using a stopwatch, as the foaming time. Besides, with respect to the taste quality, the tablet No. 1 was scored, for the following evaluation items, as any one of 1 to 5 with scores of the tablet No. 2 used as a reference (score 3). Averages of the evaluation results are shown in the lowermost rows of Table 6. Besides, the results of the taste quality are illustrated in FIG. 5.

### <<Evaluation Items for Taste Quality>>

“Persistence of Bubbles” 1: not persistent, 3: equivalent, 5: persistent

“Fineness of Bubbles” 1: coarse, 3: equivalent, 5: fine

“Density of Bubbles” 1: high density, 3: equivalent, 5: low density

“Mildness of Bubbles” 1: strong, 3: equivalent, 5: mild

“Smoothness on Tongue” 1: not smooth, 3: equivalent, 5: smooth

“Mouthfeel” 1: poor mouthfeel, 3: equivalent, 5: good mouthfeel

TABLE 6

Tablet No.

| | | | No. 1 | No. 2 |
|---|---|---|---|---|
| | Component | Erythritol Granule | 58 | 0 |
| | | Sorbitol | 0 | 58 |
| | | Citric Acid | 20 | 20 |
| | | Sodium Bicarbonate | 20 | 20 |
| | | Lubricant | 2 | 2 |
| | | Perfume | 0.5 | 0.5 |
| Foaming Time (sec) | | | 206 | 103 |
| | Taste Quality | Persistence of Bubbles | 4.5 | 3.0 |
| | | Fineness of Bubbles | 3.8 | 3.0 |
| | | Density of Bubbles | 3.0 | 3.0 |
| | | Mildness of Bubbles | 3.9 | 3.0 |
| | | Smoothness of Tongue | 3.1 | 3.0 |
| | | Mouthfeel | 3.5 | 3.0 |

As shown in Table 6, the foaming time of the tablet No. 1 was remarkably long as compared with that of the tablet No. 2. Besides, as shown in Table 6 and FIG. 5, the tablet No. 1 was remarkably highly evaluated as compared with the tablet No. 2 in the persistence, the fineness and the mildness of bubbles, and was also highly evaluated in the mouthfeel. In other words, it was revealed that a tablet containing erythritol has remarkably long foaming time in a mouth, and that erythritol imparts excellent taste quality to a foaming tablet.

1. A tablet comprising erythritol, provided that the tablet excludes food and an oral pharmaceutical.

2. The tablet according to claim 1, wherein the tablet is a tablet for use of a daily necessity.

3. The tablet according to claim 1, wherein the tablet is a tablet for use of an industrial product.

4. The tablet according to claim 1, wherein the tablet is a tablet for use of a cleaning supply.

5. The tablet according to claim 1, wherein the tablet is a bath additive or a detergent.

6. The tablet according to claim 1, wherein the tablet is a foaming tablet.

7. The tablet according to claim 6, wherein the tablet is a foaming bath additive or a foaming detergent.
